(19) United States
(12) Patent Application Publication
(10) Pub. No.: US 2010/0124687 A1
(43) Pub. Date: May 20, 2010

(54) Fluid Manager Having Fluid Injection Primer for a Fluid Consuming Battery

(75) Inventors: Michael J Brandon, II, North Ridgeville, OH (US); Chad E. Law, Huron, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: Eveready Battery Company, Inc.

(21) Appl. No.: 12/272,823

(22) Filed: Nov. 18, 2008

(51) Int. Cl. H01M 2/02

(52) U.S. Cl. 429/34

(57) ABSTRACT

A fluid consuming battery is provided that includes a fluid (e.g. air) manager for supplying fluid to the battery. The fluid manager includes a housing member defining a plenum in fluid communication with a fluid consuming electrode of a fluid consuming battery cell. The fluid manager also includes a fluid injection primer in fluid communication with the plenum for injecting fluid into the plenum. The fluid injection primer includes a manually operated air mover that moves upon user actuation to inject fluid into the plenum to the fluid consuming electrode of the battery cell. Additionally, a valve and an actuator may be provided for opening and closing the valve in response to a controller.

### BACKGROUND OF THE INVENTION

The present invention generally relates to fluid regulating batteries, and more particularly relates to supplying fluid, such as air containing oxygen, to a fluid consuming electrode of the battery.

Electrochemical battery cells that use a fluid, such as oxygen and other gases from outside the cell as an active material to produce electrical energy, such as air-depolarized, air-assisted and fuel cell battery cells, can be used to power a variety of portable electronic devices. For example, air enters into an air-depolarized or air-assisted cell, where it can be used as, or can recharge, the positive electrode active material. The oxygen reduction electrode promotes the reaction of the oxygen with the cell electrolyte and, ultimately, the oxidation of the negative electrode active material with the oxygen. The material in the oxygen reduction electrode that promotes the reaction of oxygen with the electrolyte is often referred to as a catalyst. However, some materials used in oxygen reduction electrodes are not true catalysts because they can be at least partially reduced, particularly during periods of relatively high rate of discharge.

One type of air-depolarized cell is a zinc/air cell. This type of cell uses zinc as the negative active material and has an aqueous alkaline (e.g., KOH) electrolyte. Manganese oxides that can be used in zinc/air cells are capable of electrochemical reduction in concert with oxidation of the negative electrode active material, particularly when the rate of diffusion of oxygen into the air electrode is insufficient. These manganese oxides can then be reoxidized by the oxygen during periods of lower rate discharge or rest.

Air-assisted cells are hybrid cells that contain consumable positive and negative electrode active materials, as well as an oxygen reduction electrode. The positive electrode can sustain a high discharge rate for a significant period of time, but through the oxygen reduction electrode, oxygen can partially recharge the positive electrode during periods of lower or no discharge, so oxygen can be used for a substantial portion of the total cell discharge capacity. This generally means the amount of positive electrode active material put into the cell can be reduced and the amount of negative electrode active material can be increased to increase the total cell capacity. Examples of air-assisted cells are disclosed in commonly assigned U.S. Pat. Nos. 6,383,674 and 5,079,106.

A number of approaches have been proposed to control the amount of air entering the cells. For example, valves have been used to control the amount of air such as those disclosed in U.S. Pat. No. 6,641,947 and U.S. Patent Application Publication Nos. 2003/0186099 and 2008/0085443. However, conventional valves are typically difficult to implement and typically require relatively complicated electronics or external means to operate the valves. Many valves require electrical power supplied from the battery for purposes of actuating the valve. If the battery power output is extremely low, there may be insufficient power to actuate the valve, and hence the valve may not open, thereby preventing further use of the battery.

It is therefore desirable to provide for a supply of fluid, such as air, to a fluid consuming battery sufficient to operate the battery. It is desirable to quickly provide sufficient fluid to a fluid consuming battery following storage, a period of rest or a period of low power output in order to increase the battery voltage and enable the battery to deliver high power output with minimal delay. It is desirable to provide sufficient fluid to a fluid consuming battery for the battery initial electrical actuation to open a fluid manager valve after storage, a period of rest or a period of low power output. It is desirable to provide a means of injecting fluid into a fluid consuming battery to provide a rapid increase in battery power output. It is desirable to provide a temporary increase in the rate of flow or fluid into a fluid consuming battery using a fluid manager that is simple in design, economical to manufacture and does not consume battery capacity. It is desirable to provide a temporary increase in the rate of flow of fluid into a fluid consuming battery using a fluid manager that does not use an electrically operated fan, pump, etc.

### SUMMARY OF THE INVENTION

According to one aspect of the present invention, a fluid manager is provided for supplying fluid to a fluid consuming battery. The fluid manager includes a housing member defining a plenum adapted to be in fluid communication with a fluid consuming electrode of a fluid consuming battery cell. The fluid manager also includes an air injection primer in fluid communication with the plenum for injecting fluid into the plenum. The fluid injection primer includes a fluid injection portion and a user actuated portion such that the fluid injection portion moves upon user actuation of the fluid actuated portion to inject air into the plenum for use in the fluid consuming battery cell.

According to another aspect of the present invention, a fluid consuming battery is provided. The fluid consuming battery includes a battery housing having one or more openings, a fluid consuming electrode disposed within the battery housing and in fluid communication with the one or more openings, and a fluid manager for supplying fluid to the air consuming cell. The fluid manager includes a fluid manager housing member defining a plenum in fluid communication with a fluid consuming electrode of a fluid consuming battery and a fluid injection primer in fluid communication with the plenum for injecting fluid into the plenum. The fluid injection primer includes a fluid injection portion and a user actuated portion, such that the fluid injection portion moves upon user actuation of the fluid actuated portion to inject fluid into the plenum and to the fluid consuming electrode.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a perspective view of a device containing a fluid consuming battery and a fluid manager having a fluid injection primer, according to a first embodiment;

FIG. 2 is a front view of the device including the fluid manager of FIG. 1;

FIG. 3 is a cross-sectional view taken through line III-III of FIG. 2;

FIG. 4 is a perspective view of a device including a fluid manager having a fluid injection primer and a valve, according to a second embodiment;

FIG. 5 is a top view of the device shown in FIG. 4;

FIG. 6 is an exploded assembly view of the device shown in FIG. 4;

FIG. 7 is a cross-sectional view of the device taken through lines VII-VII of FIG. 5;

FIG. 8 is a cross-sectional view of the sliding plate valve taken through line VIII-VIII of FIG. 6, illustrating the valve in the open position; and

FIG. 9 is a cross-sectional view of the sliding plate valve taken through line VIII-VIII of FIG. 6, illustrating the valve in the closed position.

### DETAILED DESCRIPTION OF THE PREFERRED EMBODIMENTS

Embodiments of this invention include a battery that includes an electrochemical cell that utilizes a fluid (such as oxygen or another gas) from outside the cell as an active material for one of the electrodes. The cell has a fluid consuming electrode, such as an oxygen reduction electrode. The cell can be an air-depolarized cell, an air-assisted cell, or a fuel cell. The battery also has a fluid manager (e.g., air manager) for controlling the passage of fluid to the fluid consuming electrode (e.g., the air electrodes in air-depolarized and air-assisted cells) to provide a sufficient amount of the fluid from outside the cell for discharge of the cell at high rate or high power, while minimizing entry of fluids into the fluid consuming electrode and water gain or loss into or from the cell during periods of low rate or no discharge. The fluid manager includes a user actuated fluid injection primer for injecting fluid into the battery for use by the fluid consuming electrode.

As used herein, unless otherwise indicated, the term “fluid” refers to fluid that can be consumed by the fluid consuming electrode of a fluid consuming cell in the production of electrical energy by the cell. The present invention is exemplified below by air-depolarized cells with oxygen reduction electrodes, but the invention can more generally be used in fluid consuming cells having other types of fluid consuming electrodes, such as fuel cells. Fuel cells can use a variety of gases from outside the cell housing as the active material of one or both of the cell electrodes.

As used herein, unless otherwise indicated, the term “user actuated” means mechanically actuated, without electrical actuation, by manual operation of the person using the fluid consuming battery.

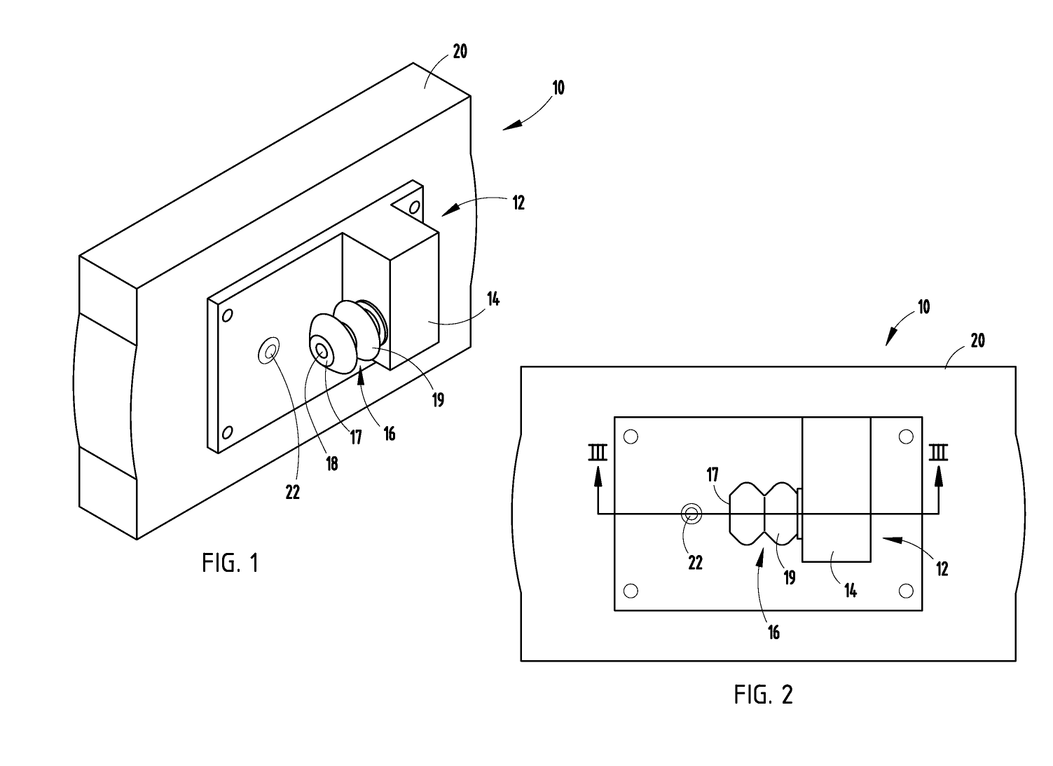

Referring now to FIGS. 1-3, a device 10 is generally shown having a fluid consuming battery 30 and a fluid manager 12, according to a first embodiment. The fluid manager 12 is embodied as an air manager in one embodiment. The fluid manager 12 includes a fluid injection primer 16 for injecting fluid, such as air, into the fluid consuming battery 30. The device 10 may include any of a number of electrically operated devices including a music player, a cell phone, a hearing aid, a flashlight, a laptop computer or other electronic devices that employ a fluid consuming battery 30. The device 10 includes a housing 20 generally defining a battery compartment 32 configured to receive the fluid consuming battery 30. It should be appreciated that any of a number of battery compartments, fluid consuming batteries and devices may be employed in connection with the fluid injection primer 16.

The fluid consuming battery 30 includes at least one electrochemical cell that utilizes a fluid (such as oxygen or another gas) from outside the cell as an active material for one of the electrodes. The battery cell 30 has a fluid consuming electrode, such as an oxygen reduction electrode. It should be appreciated that the fluid consuming battery cell 30 may contain an air-depolarized cell, an air-assisted cell or a fuel cell, and the cell and battery may have other shapes (such as button, cylindrical, and square) and sizes, according to various embodiments. In the exemplary embodiment, the fluid consuming battery cell 30 is an air-depolarized cell that uses zinc as the negative electrode active material and has an aqueous alkaline (e.g., KOH) electrolyte.

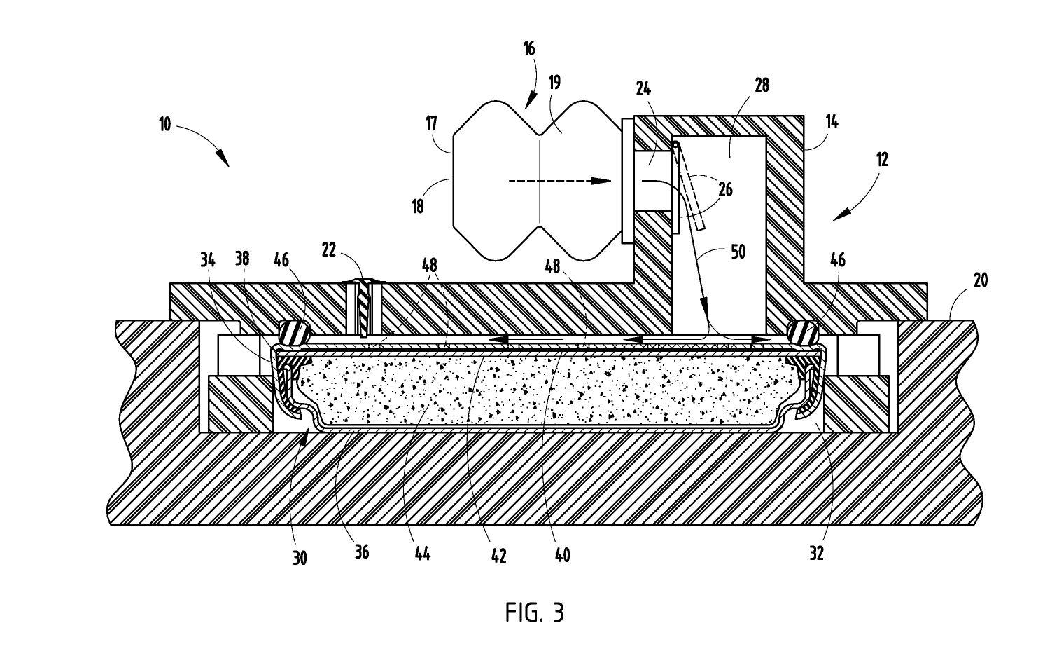

The air-depolarized cell 30 is best seen in FIG. 3 including a cell housing which may include a first housing component and a second housing component, which may include a can 34 and a cover 36, respectively, and may have shapes or sizes differing from what would otherwise be considered a can or cover. For purposes of example, the first housing component is hereinafter referred to as the can 34, while the second housing component is hereinafter referred to as the cover 36. The can 34 and cover 36 are both made of an electrically conductive material, but are electrically insulated from one another by means of a gasket 38. Can 34 generally serves as the external positive contact terminal for the fluid consuming cell 30, whereas cover 36 serves as the external negative contact terminal. Not shown in FIG. 3 are electrical contacts for electrically connecting the device to the terminals of the fluid consuming cell 30.

The battery cell 30 further includes a first electrode 40, which may be the fluid consuming electrode, referred to as an air electrode in the embodiment in FIG. 3. The battery cell 30 may also include a second electrode 44, which may be the negative electrode (i.e., anode), and a separator 42 disposed between the first and second electrodes. The first electrode 40 is electrically coupled to can 34, whereas the second electrode 44 is electrically coupled to cover 36.

The can 34 generally includes a surface shown in FIG. 3 as the top surface, in which a plurality of fluid entry ports 48 are provided such that fluid, including air, may pass to the interior of the cell housing so as to reach the fluid consuming electrode 40. Any of a number of fluid entry ports 48 of various sizes and shapes may be employed to allow fluid to pass to the fluid consuming electrode 40.

The fluid manager 12 includes a housing 14 shown overlaying the battery compartment 32 of device housing 20 and sealed against opposite ends of the top surface of the battery cell 30 by way of a seal 46. The fluid manager housing 14 may be secured to device housing 20 by way of fasteners, brackets, adhesives or other securing mechanisms.

The fluid manager housing 14 has walls that generally define a plenum 28 arranged to be in fluid communication with the fluid consuming electrode 30, particularly the fluid entry ports 48 that lead to the fluid consuming electrode 40. The plenum 28 may be of sufficient size to hold fluid for use by the fluid consuming electrode 40. The fluid manager housing 14 also has a fluid entry opening 24 in fluid communication with the fluid injection primer 16. The fluid injection primer 16 is assembled to fluid manager housing 14 at opening 24 so that fluid is injected through opening 24 and into plenum 28.

The fluid injection primer 16 is thereby in fluid communication with the plenum 28 for injecting fluid, such as air, into the plenum 28. The fluid injection primer 16 includes a fluid injection portion 19 which holds fluid and dispenses fluid into the plenum 28. The fluid injection primer 16 also includes a user actuated portion 17 and has an opening 18 in the middle thereof and is adapted to be engaged by a user's finger or hand to dispense fluid within the air injection primer 16 into the plenum 28. The air injection primer 16 is shown and described herein as a bellows, according to one embodiment. The bellows 16 has an accordion-like structure that contracts and expands. Specifically, the bellows 16 contracts when a user engages the user actuated portion 17 over opening 18 and compresses the bellows 16 to pump fluid held in the primer 16 into the plenum 28. When a user disengages the bellows 16, the bellows 16 has memory such that it expands back to its normal shape while fluid from the outside environment flows into the primer 16.

A check valve 26 can be included in the primer 16. For example, as shown in FIG. 3, check valve 26, shown as a flap that pivots or bends inward upon the bellows 16 supplying a sufficient pressure differential, is located within the fluid manager housing 14. The check valve 26 allows forced or pressurized fluid to pass from the primer 16 into the plenum 28. When pressurized or forced fluid from the bellows 16 does not exceed a threshold pressure limit, the check valve 26 closes the opening 24 to prevent fluid from flowing in or out of the plenum 28. Thus, fluid is prevented from flowing in the reverse direction from the plenum 28 to the primer 16 by check valve 26.

To assist in allowing fresh fluid to be injected into the plenum 28 and made available to the fluid consuming battery 30, the fluid manager 12 further includes a relief valve 22 shown mounted in fluid manager housing 14 near one end of the battery cell 30 opposite the plenum 28. Thus, fluid is allowed to flow into fluid injection primer 16 through opening 24 and plenum 28 to the battery cell 30 where it may enter fluid entry ports 48 to reach the fluid consuming electrode 40. Fluid is further allowed to leave the battery cell 30 through ports 48 and to exit the sealed volume of the battery compartment 32 through the relief valve 22 to the outside environment. The relief valve 22 may include a one-way or check valve that allows fluid to only pass from within the sealed volume of the battery compartment 32 to the outside environment and not in the reverse direction. It should be appreciated that the seal 46 serves to provide a sealed closure between the fluid manager housing 14 and the battery cell 30 at opposite ends of the battery 30 such that the plenum 28 and relief valve 22 are within the sealed volume.

In operation, the fluid manager 12 is actuated by a user depressing the user actuated portion 17 with a finger or hand by covering opening 18 and compressing the bellows 16 to force fluid through opening 24 and into the plenum 28 through valve 26, such that fluid is able to pass along fluid flow path 50. Fluid may flow along air flow path 50 to reach the fluid entry ports 48 and into the fluid consuming electrode of the battery cell 30. Fluid consumed by the battery cell 30 may then be purged from the sealed volume of the battery compartment 30 by passing through relief valve 22 back to the outside environment. It should be appreciated that the fluid, such as oxygen in the air, may serve as the active material to produce electrical energy within the battery cell 30. In the present embodiment, user activation of the air injection primer 16 results in a limited amount of fluid entering the battery cell 30 such that a limited amount of electrical energy may be produced by the battery cell 30. It should be appreciated that the primer 16 may be further actuated to provide additional fluid to the battery cell 30 to generate additional electrical energy. Further, it should be appreciated that the primer 16 and plenum 28 may be of various sizes including a larger size to provide a greater amount of fluid to the battery, such that a greater amount of electrical energy may be produced by battery cell 30 for a given actuation of the primer 16.

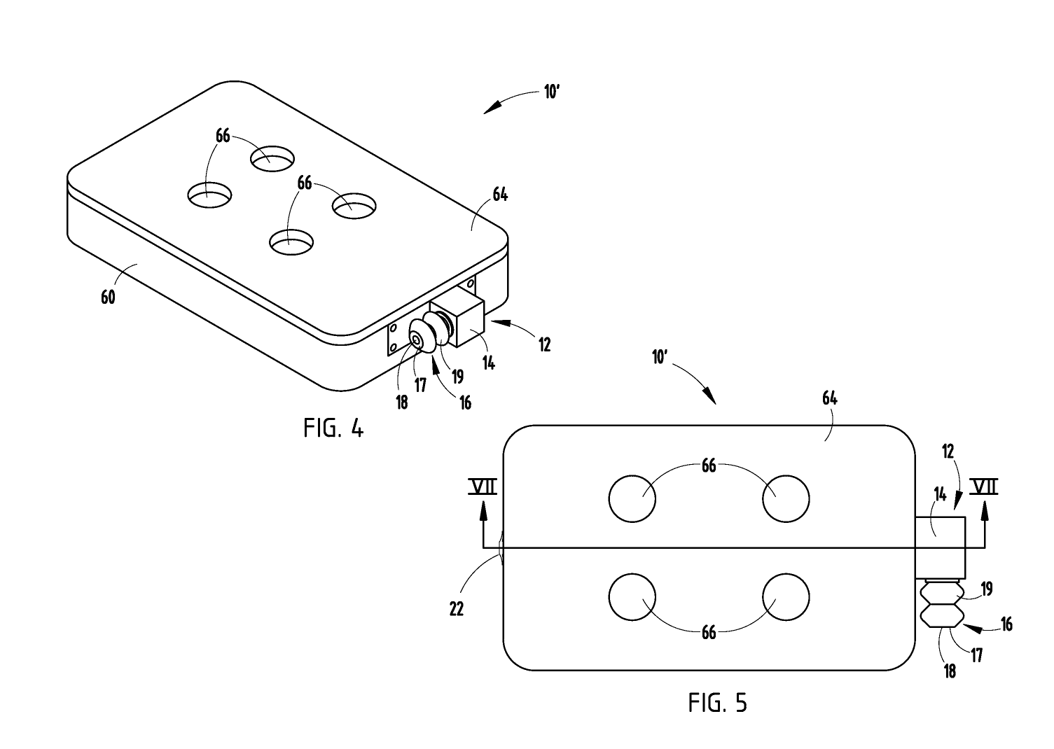

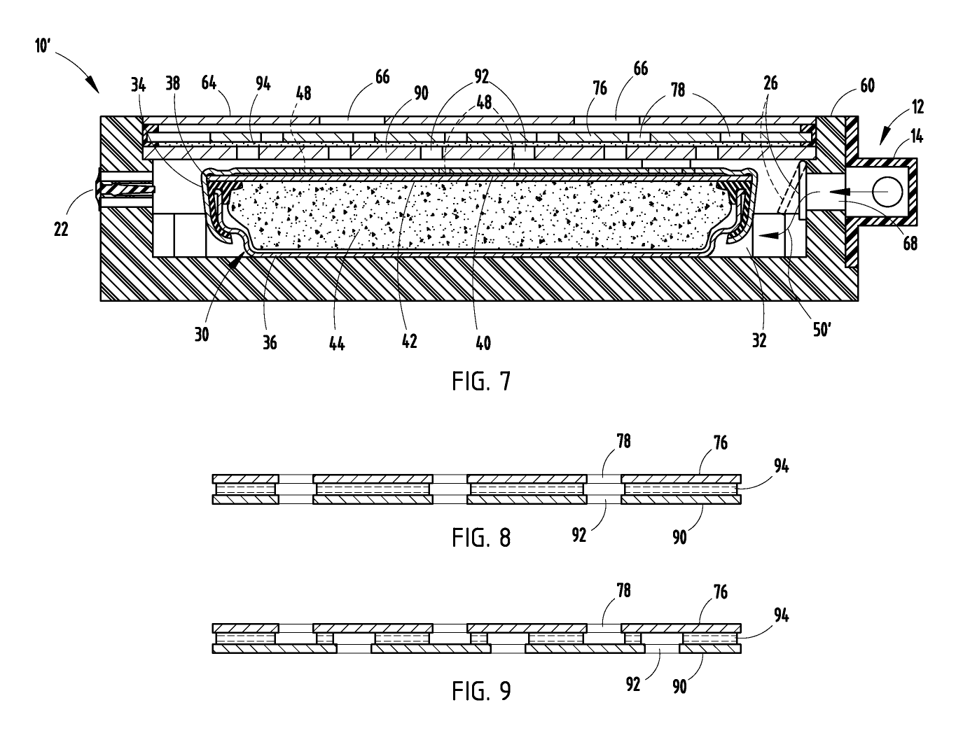

Referring to FIGS. 4-9, a device 10′ is shown employing a fluid consuming battery 30 and a fluid manager 12 which can include a first fluid manager component including fluid injection primer 16 and a second fluid manager component 70, including for example an actuatable sliding plate valve, according to a second embodiment. In this embodiment, the device 10′ may include any of a number of electrical devices and, as shown, has a battery compartment 32 made up of a battery compartment housing 60 and a lid 64 generally defining the battery compartment for receiving a fluid consuming battery cell 30. The fluid consuming battery cell 30 may include the battery as disclosed in the first embodiment. The lid 64 can include apertures 66, through which fluid can enter the battery compartment 32, in which the battery cell 30 is disposed.

In the second embodiment, the fluid manager 12 has the fluid injection primer 16 at one end of the battery cell 30, assembled to a battery compartment housing 60 as opposed to the location disclosed in the first embodiment. In the example of the second embodiment shown in FIGS. 4-9, the sliding plate valve 70 is provided and installed directly above the fluid consuming battery cell 30 as a primary means of controlling fluid supplied to the battery cell 30. It should be appreciated that fluid, such as air, may be allowed to pass from the outside environment to the fluid consuming battery cell 30 when the fluid regulating system 70 is in the open position. Additionally, fluid may be allowed to pass to the fluid consuming battery from the outside environment through the fluid injection primer 16. The fluid regulating system 70 requires electrical power to actuate the sliding plate valve. When the voltage of battery cell 30 is sufficiently low, such as when the battery cell is first put into use, the battery cell 30 may not supply sufficient power to actuate the sliding plate valve. In this situation, a user may actuate the fluid injection primer 16 as a secondary means of air introduction to the battery cell 30 so as to inject sufficient fluid through fluid entry opening 68 in the battery compartment housing 60 and into the battery cell 30 to allow for the generation of sufficient electrical power to actuate the sliding plate valve to the open valve position. The fluid injection primer 16 also subsequently serve as a secondary means of introducing fluid to the battery cell 30, thereby increasing the fluid available so the battery cell 30 which can temporarily provide greater power output.

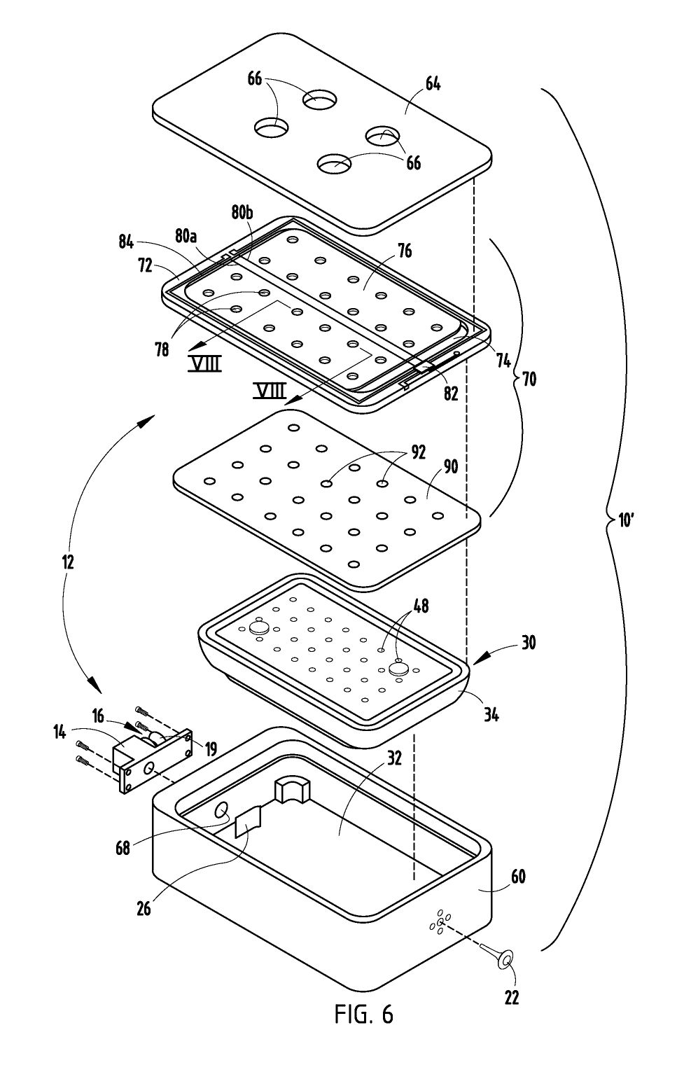

The second fluid management component 70 is shown in FIGS. 6-9, according to one embodiment as a valve that includes a fixed first plate 90 having a plurality of apertures 92, and a movable second plate 76 including a plurality of apertures 78 that can correspond in size, shape, number and position to the apertures 92 formed in the first plate 90. The size, shape, number and position of apertures 92 and 78 may be optimized to provide the desired volume and distribution of fluid applied to the fluid consuming electrode 40 of the battery cell 30.

The second fluid manager component 70 can further includes a chassis 72 having an annular body portion with an opening 74 in which the movable second plate 76 is disposed. Opening 74 may be shaped and sized to contact elongated size edges of plate 76 while providing excess space at the shorter side of plate 76, such that plate 76 may be slid linearly along an axis in parallel with its longest dimension. The apertures 78 of second plate 76 may be moved into and out of alignment with apertures 92 of first plate 90 to thereby open and close the valve. The chassis 72 guides and can retain the movable second plate 76 adjacent to the fixed first plate 90. In addition, a lubricating layer 94 (see FIGS. 8 and 9) made of a low friction material, such as oil or a film or coating of Teflon®, may be disposed between plates 76 and 90 to enable the second plate 76 to more readily slide along the surface of plate 90. Thus, the lubricating layer 94 enables the valve to be opened and closed requiring less force by the actuator. Additionally, because it may be difficult to get the surfaces of plates 76 and 90 to be sufficiently smooth so as to provide a good seal, the lubricating layer 94 may comprise an oil such as a silicon oil to enhance the sealing characteristic of the valve. It should be appreciated that one of the plates may be made of a magnetic material or other mechanism for holding plate 76 firmly against plate 90.

As seen in FIG. 6, the fluid regulating system 70 is shown including an actuator to actuate the valve. According to one embodiment, the actuator may include a control circuit 82, such as an application specific integrated circuit (ASIC) mounted to the surface of the chassis 72 and one or more shape memory alloy (SMA) components for actuating the moving plate 76 between open and closed valve positions. The one or more shape memory alloy components may include a first SMA wire 80a and a second SMA wire 80b secured at opposite ends of the chassis 72 and electrically coupled to circuit traces 84. By supplying a control signal that passes a current through the SMA wires 80a and 80b, the control circuit 82 may cause the SMA wires to heat up, which causes the SMA wires to expand or constrict to a particular length. This, in turn, causes the SMA wires to pull the moving plate 76 in one direction or the opposite direction and thus causes plate 76 to slide in and out of an open or closed position so as to selectively allow fluid to pass into the interior of the battery cell 30 when the plate 76 is in the opened valve position.

SMA wires 80a and 80b may be made with any conventional shape memory alloy. A shape memory alloy is an alloy that can be deformed at one temperature but when heated or cooled returns to its previous shape. This property results from a solid phase transformation, between the Martensite and Austenite phases. Preferred shape memory alloys have a two-way shape memory; i.e., the transformation is reversible, upon both heating and cooling. Examples of shape memory alloys include nickel-titanium, nickel-titanium-copper, copper-zinc-aluminum and copper-aluminum-nickel alloys, with nickel-titanium and nickel-titanium-copper being preferred. The use of nickel-titanium-copper (e.g., with about 5-10 weight percent copper) can be advantageous for actuators that may be operated many times because of its resistance to fatigue. Manufacturers of nickel-titanium and other shape memory alloys include Specialty Metals, Shaped Memory Alloy Division (New Hartford, N.Y., USA), Memry Corporation (Bethel, Conn., USA), and Dynalloy, Inc. (Mesa, Calif., USA).

It should be appreciated that contact terminals may be provided on the chassis 72 for connection to positive and negative terminals of the battery cell 30 so as to provide electrical current to actuate the SMA wires 80a and 80b. Additionally, it should be appreciated that the control circuit 82 may be in communication with other circuitry. Ultimately, the control circuit 82 may be integrated into a controller associated with the device and may include logic for controlling actuation of the valve between open and closed positions. The SMA wires 80a and 80b may be configured in any of a number of shapes and locations so as to provide actuation of the moving plate 76 between the open and closed positions. While the SMA actuator is shown and described herein for controlling a sliding valve, it should be appreciated that other actuators and other types of valves may be employed as the regulating system 70 for selectively controlling fluid entry to the fluid consuming battery cell 30. Disposed between the battery cell 30 and second fluid manager component 70 are standoff members 49, which serve to provide space for fluid to pass between cell 30 and component 70.

During normal operation of a device, the second fluid manager component 70 may operate to actuate the sliding plate valve 76 between open and closed positions to regulate the amount of fluid supplied to the fluid consuming battery cell 30. When greater power is required to operate a device, the sliding valve plate 76 may be actuated by the SMA wires to open the valve to allow fluid into the fluid consuming battery cell 30 which, in turn, generates increase electrical power. When sufficient electrical power is provided and the device may be turned off, the sliding valve 76 may be closed so as to prevent reduction of battery capacity. In addition, the fluid manager 12 is provided to allow a user to actuate the fluid injection primer 16 by depressing the bellows 16 to pump fluid into the plenum 28 which, in turn, supplies fluid to the battery cell 30 by way of another fluid flow path 50′. The fluid manager 12 is of particular significance in the situation when the battery cell 30 has produced insufficient electrical energy to actuate the sliding valve to the open position. In this situation, a user may actuate the primer 16 to pump fluid into the battery cell 30 to rejuvenate the battery cell 30 to generate electrical power sufficient such that the sliding valve 76 may thereafter be actuated to cause added power to be generated by the battery cell 16.

Accordingly, the fluid manager 12 advantageously provides a standalone fluid injection system for injecting fluid into a fluid consuming battery 30, according to one embodiment. According to another embodiment, the fluid manager 12 advantageously provides a secondary fuel injection system to inject fluid into the battery cell 30 when sufficient battery power is not available to control the primary fluid regulating system. The second fluid manager component 70 shown and described herein in accordance with the second embodiment may include any known fluid regulating system, such as the fluid regulating system disclosed in U.S. Patent Application Publication No. 2008/0085443, which is hereby incorporated herein by reference.

It should be appreciated that the fluid manager 12 of the present invention provides for a cost-effective and easy to use regulating system for regulating fluid input to a fluid consuming battery. The fluid injection primer 16 advantageously reduces battery air-up time, and can advantageously provide increased power initially, which can be particularly advantageous for devices with a high in-rush current or an initial high power operating mode, and increases the battery rate capability. Additionally, the fluid injection primer 16 can be used after each period of battery rest, for example when the device is turned back on after being off. The fluid manager 12 advantageously avoids the use of a requirement for a fan, pump, etc. that forces air or other fluid through the system during battery use, such as after airing up, resulting in smaller air manager volume, simple design, lower cost and no consumption of battery capacity to operate the fluid injection primer 16.

Alternative embodiments are envisioned. In the embodiments described above the fluid injection primer 16 comprises a manually operated bellows to force fluid into the battery compartment 32. In other embodiments, other types of manually actuated air movers, such as a manually cranked fan, can be used in the fluid injection primer 16. In yet other embodiments, a fluid injection primer can be incorporated into a battery housing installed in a device such that the fluid injection primer can be manually operated by the user, before installation in the device in one embodiment and after installation in the device in another embodiment. In the embodiments described above, the fluid consuming battery includes a single fluid consuming cell, but more than one fluid consuming cell can be incorporated into a single battery, and more than one fluid consuming battery may be used in a single device. In embodiments with more than one fluid consuming cell per battery or with more than one fluid consuming battery per device, each cell or battery can have a separate fluid manager, or a single fluid manager can regulate fluid for more than one cell or battery.

While the invention has been described in detail herein in accordance with certain preferred embodiments thereof, many modifications and changes therein may be affected by those skilled in the art without departing from the spirit of the invention. Accordingly, it is our intent to be limited only by the scope of the appending claims and not by way of the details and instrumentalities describing the embodiments shown herein.

What is claimed is:

1. A fluid manager for supplying fluid to a fluid consuming battery, said fluid manager comprising:
a housing member defining a plenum adapted to be in fluid communication with a fluid consuming electrode of a fluid consuming battery cell; and
a fluid injection primer in fluid communication with said plenum for injecting fluid into the plenum, said fluid injection primer comprising a fluid injection portion and a user actuated portion such that the fluid injection portion moves upon user actuation of the fluid actuated portion to inject fluid into the plenum for use in the fluid consuming battery cell.

2. The fluid manager as defined in claim 1, wherein the fluid injection primer comprises a manually operated air mover.

3. The fluid manager as defined in claim 2, wherein the manually operated air mover comprises a bellows that contracts and expands.

4. The fluid manager as defined in claim 3, wherein the bellows comprises an opening leading from the plenum to an outside environment, wherein the opening is adapted to be engaged by a user upon actuation of the user actuated portion.

5. The fluid manager as defined in claim 2, wherein the manually operated air mover comprises a manually cranked fan.

6. The fluid manager as defined in claim 1, wherein the FLUID injection portion is compressible.

7. The fluid manager as defined in claim 1 further comprising a valve for adjusting rate of passage of fluid into the fluid consuming electrode, and an actuator for operating the valve between at least open and closed positions.

8. The fluid manager as defined in claim 7, wherein the fluid manager further comprises a controller for controlling the actuator to open and close the valve.

9. The fluid manager as defined in claim 8, wherein the actuator comprises an SMA.

10. The fluid manager as defined in claim 8, wherein the valve comprises at least one moving plate, wherein the actuator moves the at least one moving plate between open and closed positions to control fluid supplied to the fluid consuming electrode.

11. The fluid manager as defined in claim 1, wherein the fluid manager is an air manager adapted to control air supplied to an air consuming battery.

12. A fluid consuming battery comprising:
a battery housing having one or more openings;
a fluid consuming cell comprising a fluid consuming electrode disposed within the battery housing and in fluid communication with the one or more openings; and
a fluid manager for supplying fluid to the fluid consuming cell, said fluid manager comprising:
a fluid manager housing member defining a plenum in fluid communication with the fluid consuming electrode; and
a fluid injection primer in fluid communication with said plenum for injecting fluid into the plenum, said fluid injection primer comprising a fluid injection portion and a user actuated portion such that the fluid injection portion moves upon user actuation of the fluid actuated portion to inject fluid into the plenum and to the fluid consuming electrode.

13. The battery as defined in claim 12, wherein the fluid injection primer comprises a manually operated air mover.

14. The battery as defined in claim 13, wherein the manually operated air movers comprises a bellows that contracts and expands.

15. The battery as defined in claim 14, wherein the bellows comprises an opening leading from the plenum to an outside environment, wherein the opening is adapted to be engaged by a user upon actuation of the user actuated portion.

16. The battery as defined in claim 13, wherein he manually operated air mover comprises a manually cranked fan.

17. The battery as defined in claim 12, wherein the fluid injection portion is compressible.

18. The battery as defined in claim 12 further comprising a valve for adjusting rate of passage of fluid into the fluid consuming electrode, and an actuator for operating the valve between at least open and closed positions.

19. The battery as defined in claim 18, wherein the fluid manager further comprises a controller for controlling the actuator to open and close the valve.

20. The battery as defined in claim 19, wherein the actuator comprises an SMA.

21. The battery as defined in claim 19, wherein the valve comprises at least one moving plate, wherein the actuator moves the at least one moving plate between open and closed positions to control fluid supplied to the fluid consuming electrode.

22. The battery as defined in claim 12, wherein the fluid consuming cell battery comprises an air consuming cell and the fluid manager comprises an air manager.
